(19) United States
(12) Patent Application Publication
(10) Pub. No.: US 2017/0052926 A1
(43) Pub. Date: Feb. 23, 2017

(54) SYSTEM, METHOD, AND COMPUTER PROGRAM PRODUCT FOR RECOMMENDING CONTENT TO USERS

(71) Applicant: CI&T, Campinas (BR)

(72) Inventors: Daniel Vieira VIVEIROS, Campinas (BR); Gilmar José Alves DE SOUZA, JR., Campinas (BR); Marcio CYRILLO, Campinas (BR)

(73) Assignee: CI&T, Campinas (BR)

(21) Appl. No.: 14/987,421

(22) Filed: Jan. 4, 2016

Related U.S. Application Data
(60) Provisional application No. 62/206,098, filed on Aug. 17, 2015.

(51) Int. Cl. G06F 17/21; H04L 29/08

(52) U.S. Cl. CPC G06F 17/212; H04L 67/306; H04L 67/22

(57) ABSTRACT

The present disclosure relates to a system, method, and computer program product for recommending content to users. a plurality of content cards is generated by a system based on user data associated with a user. a display order for the plurality of content cards is determined by the system based on a plurality of recommendation algorithms. The plurality of content cards is provided by the system on a user interface of a user device of the user based on the display order

### BACKGROUND

Content providers provide a variety of content, for example, movies, videos, songs, articles, blogs, and products to users through communication networks, such as the internet. The users access such content through computing devices, such as laptops, desktops, tablets, and smartphones. In order to provide relevant content to the users, the content providers typically implement a recommendation system. The recommendation system is a system designed to recommend content to users based on defined rules and algorithm. For instance, a recommendation system may be designed to recommend content to a user based on a type of content which the user is currently browsing. Thus, relevant content is provided to the users.

### SUMMARY

The present disclosure relates to a system, a method, and a computer program product for recommending content to users. According to an embodiment, the system includes a processing unit. The processing unit is configured to generate a plurality of content cards based on user data associated with a user. The processing unit is further configured to determine a display order for the plurality of content cards based on a plurality of recommendation algorithms. The processing unit is further configured to provide the plurality of content cards on a user interface of a user device of the user based on the display order.

According to an embodiment, the method includes generating a plurality of content cards based on user data associated with a user. Further, the method includes determining a display order for the plurality of content cards based on a plurality of recommendation algorithms. The method further includes providing the plurality of content cards on a user interface of a user device of the user based on the display order.

According to an embodiment, the computer program product includes a non-transitory computer readable storage medium, and a computer program code embedded in the non-transitory computer readable storage medium for causing a processor to generate a plurality of content cards based on user data associated with a user. The computer program code further causes the processor to determine a display order for the plurality of content cards based on a plurality of recommendation algorithms. The computer program code further causes the processor to provide the plurality of content cards on a user interface of a user device of the user based on the display order.

The above summary is not intended to be an exhaustive discussion of all the features or embodiments of the present disclosure. A more detailed description of the features and embodiments of the present disclosure will be described in the detailed description section.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates a network environment implementing an exemplary system for recommending content to users, in accordance with an embodiment.

FIG. 2 illustrates a detailed network environment implementing an exemplary system for recommending content to users, in accordance with an embodiment

FIG. 3 illustrates an exemplary method for recommending content to users, in accordance with an embodiment.

FIG. 4 illustrates an exemplary layout of a content card, in accordance with an embodiment.

FIG. 5 illustrates an exemplary user interface, in accordance with an embodiment.

FIG. 6(A) illustrates an exemplary user interface, in accordance with an embodiment.

FIG. 6(B) illustrates an exemplary user interface, in accordance with an embodiment.

FIG. 7 illustrates exemplary user interface orientations, in accordance with an embodiment.

FIG. 8 illustrates an exemplary use case, in accordance with an embodiment.

It is to be noted that like reference numerals designate identical or corresponding components throughout the drawings.

### DETAILED DESCRIPTION

The present disclosure provides a system, a method, and a computer program product for recommending content to users. According to an embodiment of the present subject matter, a plurality of content cards is generated based on user data associated with a user. The user data may include personal information, employment information, and other information associated with the user. The personal information may include, for example, a name, an age, a gender, a profession, and a geographic location of the user. The employment information may include, for example, an enterprise name, a designation, and a skill set of the user. The other information may include, for example, information associated with family, friends, and groups of the user, browsing history of the user, and information associated with content viewed, read, liked, disliked, pinned, tagged, shared, followed and so forth, by the user.

Once the plurality of content cards are generated, a display order for the plurality of content cards is determined based on a plurality of recommendation algorithms. In an example, at least one recommendation algorithm may be based on the user and at least one recommendation algorithm may be based on the content. Thereafter, the plurality of content cards is provided on a user interface of a communication device of the user based on the display order. Determining the display order of the content cards based on the plurality of recommendation algorithms facilitates in providing relevant content to the user.

As will be appreciated by one skilled in the art, aspects of the present disclosure may be embodied as a system, method or computer program product. Accordingly, aspects of the present disclosure may take the form of an entirely hardware based embodiment, an entirely software based embodiment (including firmware, resident software, micro-code, etc.) or an embodiment combining software and hardware features that may all generally be referred to herein as a “system”, “device” or “apparatus”. Furthermore, aspects of the present disclosure may take the form of a computer program product embodied in one or more non-transitory computer readable medium(s) having computer readable program code embodied thereon.

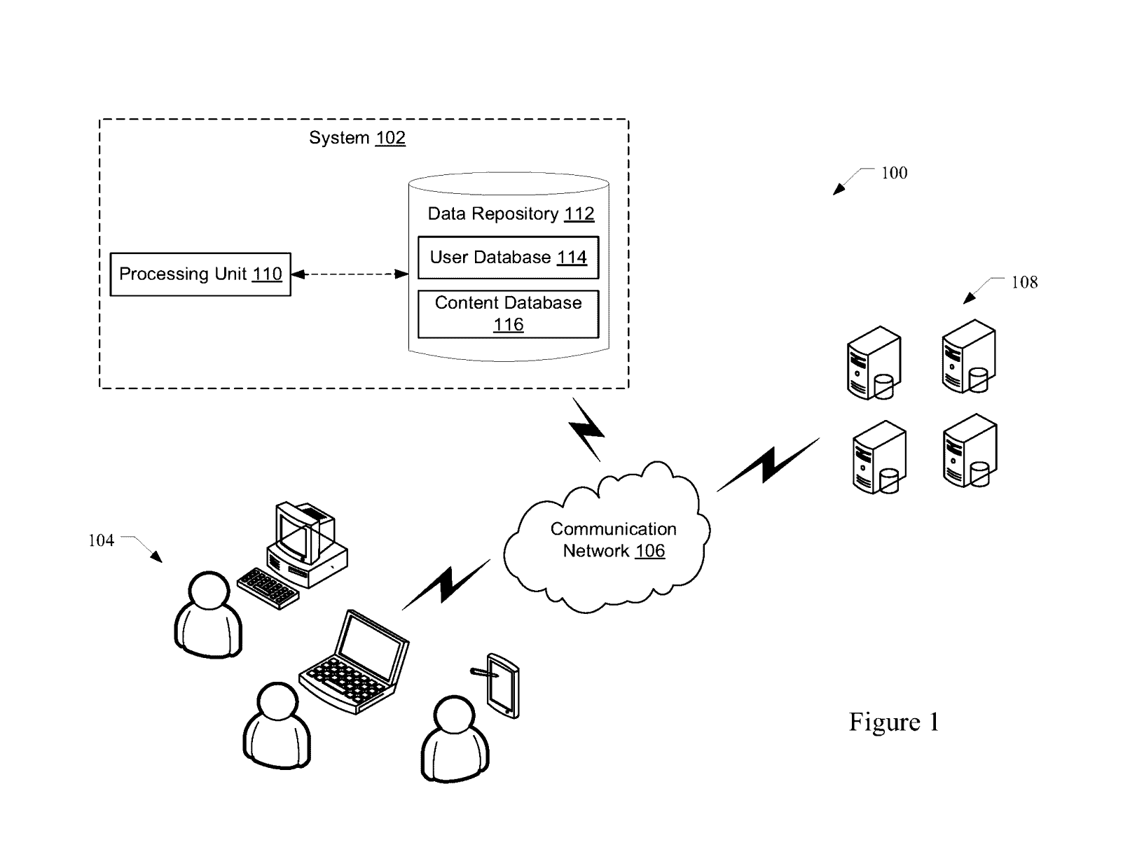

Referring now to the Figures, FIG. 1 illustrates an exemplary network environment 100 implementing an exemplary system 102 for recommending content to users, in accordance with an embodiment. The system 102 may be implemented across various domains for providing content which may be of relevance to the user. For instance, the system 102 may be implemented by content providers, such as, multimedia streaming websites, online gaming websites, news websites/aggregators, blogs, search engines, online shopping portals, any third party websites, and the like. In another example, the system 102 may be implemented by enterprises for providing relevant content to its employees. In an example embodiment, the system 102 may implemented over a cloud platform, such as the Google cloud platform. Implementing the system 102 over a cloud platform enhances the scalability of the system 102. For instance, the system 102 may be implemented based on a software-as-a-service (SaaS) model over the cloud platform.

As shown in the FIG. 1, the system 102 is coupled to a plurality of communication devices of a plurality of users 104 via a communication network 106. The system 102 may be implemented using one or more computing devices, such as a server, a cloud server, a workstation computer, a laptop, and the like. Examples of the communication devices may include a smartphone, a mobile phone, a personal digital assistant (PDA), a laptop, a tablet, a smartwatch, and the like.

Further, as shown in the figure, the system 102 and the users 104 may be connected to a plurality of data sources 108 through the communication network 106. The plurality of data sources 108 represents data servers, databases, and data repositories, implemented by one or more content providers, public organizations, third party information gathering organizations, and enterprises. Examples of the content providers may include multimedia streaming websites, online gaming websites, news websites/aggregators, blogs, search engines, any third party websites, and the like. Based on the implementation, the data sources 108 may comprise content and/or information associated with the users 104. For instance, a data source 108 may be implemented by a content provider of videos for storing videos that may be provided to the users 104 and/or videos uploaded by the user 104. In another example, a data source 108 may be implemented by a social networking platform for storing information associated with the users. In yet another example, a data source 108 may be implemented by an enterprise to store enterprise content and employee data associated with its employees. The enterprise content may include, for example, public content, such as press releases, news items, investor documents, and the like. The enterprise content may further include private content, for example, internal training modules, reports, presentations, and the like.

The system 102 includes a processing unit 110 and a data repository 112 coupled to the processing unit 110. The data repository 112 includes a user database 114 for storing a plurality of user profiles associated with the users 104. The data repository 112 further includes a content database 116 for storing content cards for the users 104. In an example, the system 102 may implement the data repository 112 based on a distributed data processing framework, such as the Hadoop framework, for reducing the computational time associated with various processes described herein. In said example, a java based file system, such as the Hadoop Distributed File System (HDFS), may be implemented for storage of data in the data repository 112.

In an embodiment, the system 102 may be configured to generate user data associated with each of the plurality of users 104. As described above, the user data associated with a user 104 includes personal information associated with the user 104, employment information associated with the user 104, and other information associated with the user 104. For generating the user data associated with a user 104, in an example, the processing unit 104 may establish a communication link with the data sources 108. Based on the data sources 108, the processing unit 110 may generate the user data. For instance, based on the data sources 108 corresponding to insurance companies, credit card companies, and the like, the processing unit 110 may generate the personal information associated with the user 104. In another embodiment, the processing unit 110 may be configured to generate the personal information associated with the user 104 based on a user profile of the user. In an example, the user profile associated with the user 104 may include a user name, an age, a gender, a profession, and a geographic location of the user 104. The system 102 may obtain such information from the user at a time when the system 102 creates the user profile or may obtain such information dynamically.

The processing unit 110 may generate the employment information associated with the user 104 based on a data source 108 corresponding to an enterprise with which the user is associated. Further, for generating the other information, the processing unit 110 may communicate with the communication device of the user for obtaining the browsing history of the user. Additionally, the processing unit 110 may obtain necessary user permissions for accessing one or more user accounts that the user may have with various websites and platforms, such as online gaming websites, multimedia streaming websites, image hosting websites, social networking platforms, news websites, blogs/articles websites, and the like. Based on the user permissions, the processing unit 110 may access the data sources 108 hosting the aforementioned user accounts. On accessing the data sources 108, the processing unit 110 may obtain information associated with family, friends, and groups of the user, and information associated with content viewed, read, liked, disliked, pinned, tagged, shared, followed and so forth, by the user. Thus, as described herein, the system 102 provides support for integrating content from a plurality of data sources.

In addition to the aforementioned data sources 108, in an example, the system 102 may be configured to obtain at least a part of the user data based on the communication device of the user 104. For example, the processing unit 110 may be configured to access applications, notes, and an internal memory of the communication device and extract at least a part of the user data. As an example, the processing unit 110 may be configured to access an internal memory of the communication device of the user and may scan through the multimedia files stored therein to determine the other information associated with the user. Thus, the communication device may also serve as a data source 108, in an embodiment. In an example, the processing unit 110 may store the user data associated with the user 104 in the user database 114.

In an embodiment, the processing unit 110 may be configured to obtain content, for example, videos, images, audios, news articles, blogs, products, and the like which may be of relevance to the user 104 based on the user data associated with the user 104. Content which may be of relevance to a user 104 may hereinafter interchangeably be referred to as relevant content. In said embodiment, the processing unit 110, at first, may determine a plurality of user preferences for the user based on the user data. Without limitations, the user preferences may be understood as types and genres of content which may be of interest to the user. For instance, based on videos viewed by the user in the past, the processing unit 110 may determine that the user likes videos (type of content) pertaining to action movies (genre of content). In another example, based on the audio streamed by the user, the processing unit 110 may determine that the user likes audio (type of content) pertaining to rock genre of music. In another embodiment where the system 102 is implemented in an enterprise, the processing unit 110 may determine the user preferences based on the professional information. For instance, for an employee designated as a manager in the enterprise, the processing unit 110 may determine that the content which may be of interest to the user may include, without limitation, meeting schedules and reports, such as growth reports associated with the enterprise, performance reports of the team members, accounts reports, and the like. Thus, as explained, the processing unit 110 determines the plurality of user preferences based on the user data.

Once the user preferences are determined, the processing unit 110 may access the data sources 108 for fetching the relevant content for the user 104. In an example, the processing unit 110 is configured to store the relevant content in the content database 116.

In an embodiment, the processing unit 110 may be configured to generate a plurality of content cards based on the relevant content stored in the content database 116. Each of the plurality of content cards may comprise at least a part of the relevant content. For instance, one content card may include a video file, another content card may include an audio file, and yet another content card may include a news article. In another example, a content card may include more than one type of content. For instance, for a multimedia content, for example, a song, the content card may include a video file and an audio file corresponding to the song.

In an embodiment, the processing unit 110 is configured to determine a display order for the plurality of contents based on a plurality of recommendation algorithms. The display order may be understood as an order or arrangement in which the content cards are displayed on a user interface. Determining the display order based on the plurality of recommendation algorithms ensures that content most relevant to the user is displayed first to the user. Thus, the probability of the user 104 to engage with the content card is increased. In an embodiment, the plurality of recommendation algorithms may include at least one recommendation algorithm based on the user and at least one recommendation algorithm based on the content cards.

On determining the display order, the processing unit 110 is configured to provide the plurality of content cards on a user interface of the communication device of the user 104 based on the display order. For example, the processing unit 110 may transmit the content cards and display order data to the communication device of the user 104. In an example, the display order data may include information and instructions to display the content cards based on the display order. In response, the communication device may display the content cards on a user interface of the communication device based on the display order.

As mentioned above, in an embodiment, the system 102 may be implemented in an enterprise network. In said embodiment, the system 102 may access a data source 108 of the enterprise and may generate the user data associated with a plurality of employees associated with the enterprise. As mentioned above, the data source 108 of the enterprise may comprise enterprise content. The enterprise content may include, for example, public content, such as press releases, news items, investor documents, and the like. The enterprise content may further include private content, for example, internal training modules, reports, presentations, and the like. The system 102 may then determine the user preferences for the employees and subsequently fetch the relevant content for the employees. The system 102 may then determine, for each of the employees, a display order in which the content cards are to be displayed to the employee. The display order, as explained above, is determined based on the plurality of recommendation algorithms. In an example, when an employee logs in through the user interface of the internal portal, the system 102 may provide the plurality of content cards for the user based on a display order determined for the employee. Thus, relevant content is provided to the user. For instance, in an example, an employee who is a manger in the enterprise may be provided with content, such as meeting schedules and reports comprising internal content of the enterprise. Further, in an example, the manger may be provided with content cards corresponding to team members of a team managed by the manager. The content cards of the team members may indicate personal information and employment information of the team members. Further, in an embodiment, the system 102 may be configured to generate a task based on an input received from the employee. For instance, the manager may provide an input to create a work task for one or more team members. Once the task is created, the system 102 may facilitate the manager to add team members to the task. In an example, the system 102 may comprise a search tool to the employees. The search tool may be used by the employees for accessing the content stored in the data source 108 of the enterprise. For instance, the manager may utilize the search tool for searching for employees with defined skill set. In yet another embodiment, the system 102 may provide a platform associated with an ongoing project for facilitating the employees associated with the project to communicate through the platform. Thus, the system 102 reduces the dependency on email exchanges occurring over the network, thereby optimizing the bandwidth utilization. Further, in an embodiment, the system 102 may be configured to convert internal content, for instance, project reports in various formats to a defined format associated with the content cards. The system 102 may then transmit the content cards to one or more employees of the enterprise. In yet another embodiment, the system 102 may be configured to edit the content cards based on a user input. For instance, in case an employee wants to update his personal information, the system 102 may receive the updated information with the user request. Based on the user request, the system 102 may update the employee information in the data source 108 and may subsequently update the content card for the employee.

In an embodiment, the system 102 may be implemented by an entity providing various types of content to the users. For instance, a shopping portal providing various products to the users 102 may implement the system 102. In such a case, the system 102 provides a central portal for displaying various products of the shopping portal. As the products are displayed based on the plurality of recommendation algorithms, content most relevant to the users are displayed first. Thus, probability of a user engaging with the product is increased. Similar to the shopping portal, the system 102 may be implemented by a shopping mall enterprise. Thus, users accessing the shopping mall's website are provided with products most relevant to them. In an embodiment, where an application corresponding to the shopping mall enterprise is installed in the communication device of the user, for instance, in a smartphone of the user, the system 102 may be configured to provide one or more shopping updates in the form of content cards to the users in real time, for instance, based on a user location of the user. In said embodiment, the system 102 may determine a location of the user based on a wifi access point or a beacon. In case the user's location is in a defined vicinity of the shopping mall, the system 102 may transmit an update message comprising information associated with one or more offers going on in one or more stores of the shopping mall.

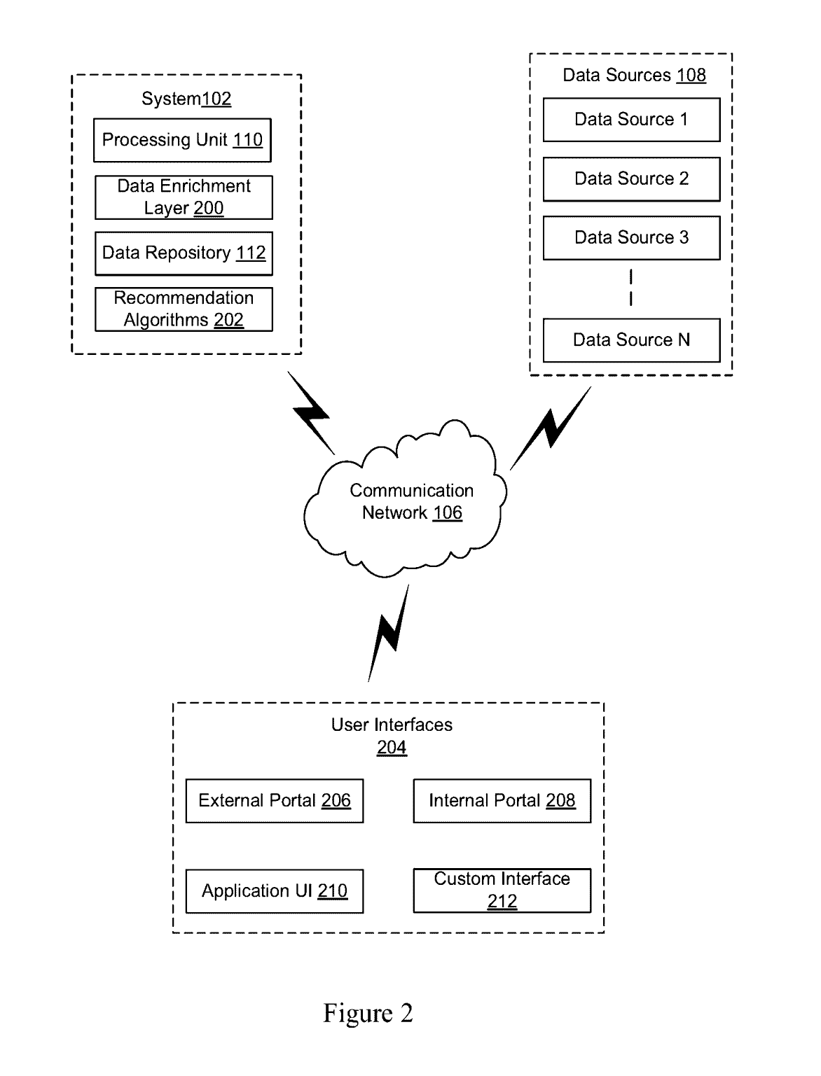

FIG. 2 illustrates an architecture level implementation of the system 102, in accordance with an embodiment. As shown in the figure, the system 102 comprises a data enrichment layer 200 and a plurality of recommendation algorithms 202. The data enrichment layer 200 comprises one or more tools, for example, programming languages and tools, such as python, pig, and mahout, for facilitating the operations of the system 102. The data enrichment layer 200 further comprises one or more application programming interfaces (APIs) for facilitating the operations of the system 102. The data sources 108 comprises data source 1, 2, 3, . . . , and N. Further, user interfaces 204 have been illustrated. The user interfaces 204 depict various example user interfaces through which the content cards may be displayed to the users 104. In an example, the user interfaces 204 comprises an external portal 206, an internal portal 208, an application user interface 210, and a custom interface 212.

In an example, user data associated with the user is generated. In an embodiment, the data enrichment layer 200 is programmed to generate the user data based on the data sources 108. The data enrichment layer 200 accesses the data sources 108 using APIs, for example, a sensor API and a user API. Subsequently, the data enrichment layer 200 generates the user data. Once the user data is generated, the data enrichment layer 200 may determine a plurality of user preferences associated with the user based on the user data. In an example, the data enrichment layer may implement a tool, for example, a machine learning tool for determining the user preferences. Subsequently, the data enrichment layer 200 may generate the plurality of content cards based on the user preferences using a content cards API. For instance, based on the user preferences, the data enrichment layer 200 may fetch relevant content for the user. Once the relevant content is fetched, the data enrichment layer 200 converts the relevant content to a plurality of content cards. In an example, the data enrichment layer 200 may convert the relevant content into a defined format associated with the content cards. The defined format may be understood as a layout in which the content is presented to the user. In an example, the user data and the content cards may be stored in the data repository 112.

In an embodiment, the system 102 may execute the plurality of recommendation algorithms 202 to determine a display order for the plurality of content cards. Each of the plurality of recommendation algorithms 202, when executed, may recommend a display order of the content cards. The display order may be understood as an order, or a sequence, or an arrangement in which the content cards are displayed to the user. In an embodiment, the plurality of recommendation algorithms 202 comprises at least one recommendation algorithm based on user data. The at least one recommendation algorithm facilitates in determining the display order based on user data. The following description describes example cases where the at least one recommendation algorithm determines the display order of the content cards based on the user data.

In an example, the recommendation algorithm may determine the display order of the content cards based on content cards liked by other users having similar user attributes as that of the user. In said example, the system 102 may first determine other users similar to the user based on the user attributes. Example of the user attributes includes, but are not limited to, age, gender, nationality, interests, and location. On determining the other users, the system may determine the display order based on the content cards liked by the other users. For instance, a content card liked by one or more of the other users may be determined to be more relevant to the user and may thus, be positioned at a higher position in the display order. Such a recommendation algorithm may use user-based collaborative filtering techniques.

In another example, the recommendation algorithm may be configured to monitor the content cards with which the user has interacted with in the past. In said example, the recommendation algorithm may determine one or more relevant text in the content cards based on predetermined rules. Subsequently, the recommendation algorithm may generate a user preference vector for the user based on the relevant texts. The user preference vector comprises a weighted average of the one or more relevant texts. Based on the user preference vector, the recommendation algorithm may then determine the display order. For instance, the content cards may be arranged in a manner such that content cards having texts similar to the relevant text may be positioned higher in the display order.

In another example, the recommendation algorithm may determine the display order of the content cards based on content cards with which the user has previously interacted. In said example, the recommendation algorithm identifies the content cards which are frequently accessed together with content cards with which the user had previously interacted. Such content cards are then positioned higher in the display order.

In yet another example, the recommendation algorithm may be configured to determine the display order based on user actions. For instance, content cards which have been disliked by the user may be positioned lower in the display order. In another example, such content cards may not be displayed altogether.

In an example, the recommendation algorithm is programmed to determine whether the user is a new user or not, for instance, based on a number of interactions the user had with the content cards or a UI through which the user is accessing the content cards. In case if the number of user interactions is less than a defined threshold, the user is classified as a new user. In such a case, the recommendation algorithm is configured to display a first set of content cards to the user. The first set of content cards may be determined based on defined rules. For instance, say a user signs up with a shopping portal and is determined to be a new user, the system 102 may provide a set of defined content cards, for example, content cards related to products on sale, to the user.

In an embodiment, the plurality of recommendation algorithms comprises at least one recommendation algorithm based on the content cards. In said embodiment, the recommendation algorithm determines the display order based on a set of attributes associated with the content cards generated for the user. The set of attributes may include may include one or more flags which when set may affect the position of the content card in the display order. The following description describes example cases where the at least one recommendation algorithm determines the display order of the content cards based on the content cards.

In an example, a first flag associated with each of the content cards may indicate a timestamp indicative of a time of generation of the content cards. In an example, the recommendation algorithm may arrange the content cards based on the first flag, i.e., recently generated cards are positioned higher in the display order with the most recently generated card being positioned at the top. Similarly, the oldest generated content card would be positioned at the bottom of the display order.

In an example, a second flag associated with the content cards may indicate a fixed position at which the content card is to be displayed. Such cards, for example, may include advertisements. In an example, the recommendation algorithm may determine the display order based on the second flag. For instance, content cards for which the second flag is set are arranged in the display order in a manner such that they are displayed at their fixed positions. For instance, a content card may be displayed at a header section of a UI on which the content cards are displayed.

In yet another example, the recommendation algorithm may determine the display order based on a content card score associated with the cards. The content card score may be defined as a numerical score based on which the content card is positioned in the display order. The content card score may be determined based on one or more user actions, for example, like, share, follow, dislike, and selection. Each user action may have a value assigned to it. For instance, a like may have a value four assigned to it and a dislike may have a value minus one assigned to it. Thus, based on the values associated with the user actions related to a content card, the content card score may be determined.

In an embodiment, the plurality of recommendation algorithms may comprise a custom recommendation algorithm. The custom recommendation algorithm may be a combination of the user data based recommendation algorithm and content card based recommendation algorithm. In another example, the custom recommendation algorithm may be based on defined rules.

In an example, a recommendation algorithm may be configured to determine the display order of the content cards based on user interactions with the content cards. For instance a user 1 may like a content card A and a user B might comment on the content card A. The user action “like” may have a value one and the user action “comment” may have a value four. Thus, based on the user actions with respect to the content card A, the recommendation algorithm may determine that the user 2 is more likely to engage with the content card A. Accordingly, the recommendation algorithm may determine the display order for the users 1 and 2. For instance, for user 2, the recommendation algorithm may determine other content cards comprising content similar to the content card A.

As mentioned above, each of the plurality of recommendation algorithms 202 may determine a display order for the content cards. In an example, the display order may be determined based on a run sequence of the recommendation algorithms 202. Thus, the display order may be finalized based on an algorithm which was executed first. In another embodiment, each of the recommendation algorithms may be assigned a weight. In said embodiment, the display order may be finalized based on the weights of the algorithms. For instance, a display order determined by a recommendation algorithm having the maximum weight may be selected or a display order may be determined by combining results of each of the recommendation algorithms using respective weights.

Determining the display order based on the plurality of recommendation algorithms 202 thus, facilitates in providing content most relevant to a user at the top of the display order. Thus, the user's engagement with the content is extended.

Once the display order is determined, the system 102 is configured to provide the plurality of content cards to at least one of the user interfaces 204. The user interfaces depict various example UIs of communication devices of the user. In an example, the plurality of content cards may be displayed on the external portal 206. An example of the external portal 206 may include a web browser through which the user is accessing content. In yet another example, the plurality of content cards may be displayed through the internal portal 208. An example of the internal portal may include a platform running on communication devices coupled to an enterprise network. In said example, the employees may access content associated with the enterprise and associated with other employees through the internal portal 208. In yet another example, the plurality of content cards may be displayed through the application UI 210. An example of the application UI 210 may include UI of a mobile application running on a mobile phone or smartphone of the user. In yet another example, the plurality of content cards may be displayed through the custom interface 212. An example custom UI 212 may include, without limitation, UI of a smart watch of the user.

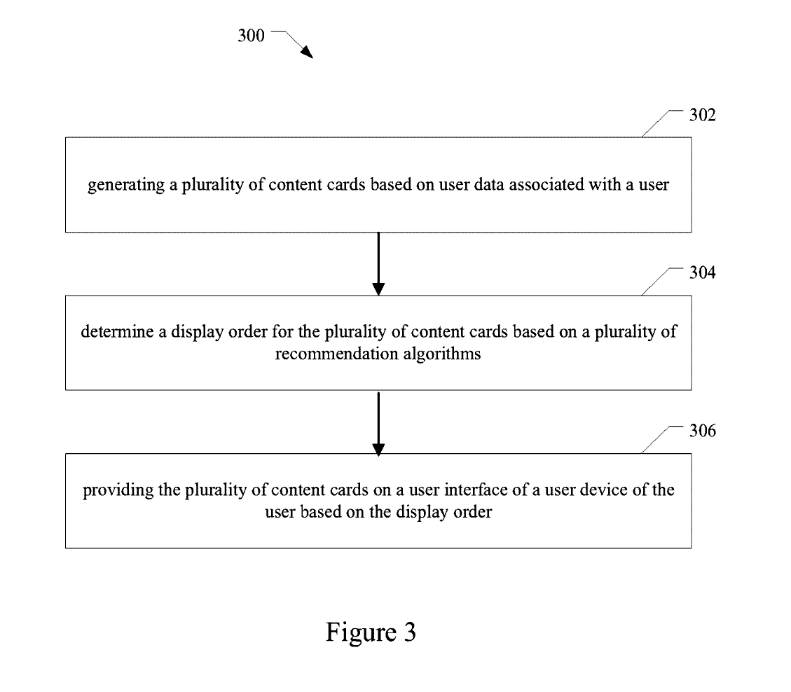

Method of recommending content to users is now described in detail with reference to FIG. 3. As such, the depicted order and labeled steps are indicative of one embodiment of the presented method. Other steps and methods may be conceived that are equivalent in function, logic, or effect of one or more steps or portions thereof, of the illustrated method. Additionally, the format and symbols employed are provided to explain the logical steps of the method and are understood not to limit the scope of the method.

Referring to the FIG. 3, an exemplary method 300 for recommending content to users is illustrated. At step 302, a plurality of content cards is generated based on user data associated with a user. The user data, in an example, may comprise personal information associated with the user, employment information associated with the user, and other information associated with the user. In an example, the user data may be generated based on a plurality of data sources. The data sources represent data servers, databases, and data repositories implemented by content providers, third party information gathering systems, public data organizations, enterprises, and the like. For generating the content cards, in an example, a plurality of user preferences associated with the user is determined based on the user data. For example, content liked, disliked, followed, shared, pinned, and viewed is determined. In an example, a machine learning technique may be implemented for determining the user preferences based on the user data. Once the user preferences are determined, relevant content is fetched from the data sources. Subsequently, the content cards are generated based on the relevant content. Each of the content cards may comprise a part of the relevant content. For instance, in a case where a blog which may be of relevance to the user is fetched, a content card comprising the blog may be generated. The content card, in an example, may include the whole write up content of the blog along with any photos, audios, and videos associated with the blog. In another example, the content card may only include a brief synopsis of the blog and may further include a URL for the blog. If the user seeks to engage further with the blog, the user may access the blog using the URL provided in the content card. Further, in an example, the user may interact with the blog using one or more user action components associated with the content card. The user action components may facilitate the user to like, dislike, share, pin, and so forth, the content card. In an embodiment, each of the content cards may be of a defined format. The defined format may be understood as a layout based on which the part of the relevant content included in the content card is displayed. In an example, the part of the relevant content which is to be displayed through the content card may be formatted so as to make the part of the content compatible with the defined format. Thus, irrespective of the source of the content, the content is presented as per the defined format of the content cards. In an implementation, the system 102 may generate the plurality of content cards.

At step 304, a display order for the plurality of content cards is determined based on a plurality of recommendation algorithms. The display order may be defined as an order, a sequence, or an arrangement in which the content cards may be displayed on a user interface. In an example, at least one recommendation algorithm from the plurality of recommendation algorithms may be based on the user and at least one recommendation algorithm from the plurality of recommendation algorithms may be based on the content cards. The display order for the content cards may be determined in a manner as described in the FIG. 2. In an example, the system 102 may determine the display order for the plurality of content cards.

At step 306, the plurality of content cards is provided on a user interface of a communication device of the user based on the display order. Once the display order is determined, the plurality of content cards and display order data may be transmitted to the communication device. The display order data comprises information and instructions to display the plurality of content cards on the user interface of the communication device based on the display order. Thus, most relevant content cards are presented first or more prominently to the user. In an example, the system 102 may provide the plurality of content cards on the user interface of the communication device based on the display order.

In another embodiment, the user's interaction with the content cards may be monitored. For instance, one or more user actions performed by the user in the user interface may be monitored. Examples of the user actions may include, but are not limited to, click, like, share, pin, dislike, comment, search, and selection. Subsequently, each of the user actions is assigned a value. In an example, the value may be a numerical value. For instance, a like may be assigned a numerical value of four while, a dislike may be assigned a numerical value minus one.

In an example, the user preferences associated with the user may be updated based on the values assigned to the user actions to obtain updated user preferences. The updated user preferences may then be used for updating the plurality of content cards provided to the user. For instance, relevant content may be updated based on the updated user preferences and subsequently, content cards generated on the updated relevant content may be provided to the user.

Based on the user's interaction with the content cards, an entity implementing the system 102 may perform several analytics for improving operations thereof For instance, the entity may learn about the content which is of interest to the user. On a large scale, i.e., by monitoring a plurality of users, the entity may learn about the success of their products. For instance, a mobile phone manufacturing enterprise may learn about the success of their mobile phone models based on the users' interaction with the content cards comprising the mobile phone models. Based on the users' interaction, the entity determines the successful products and may enhance their operations accordingly.

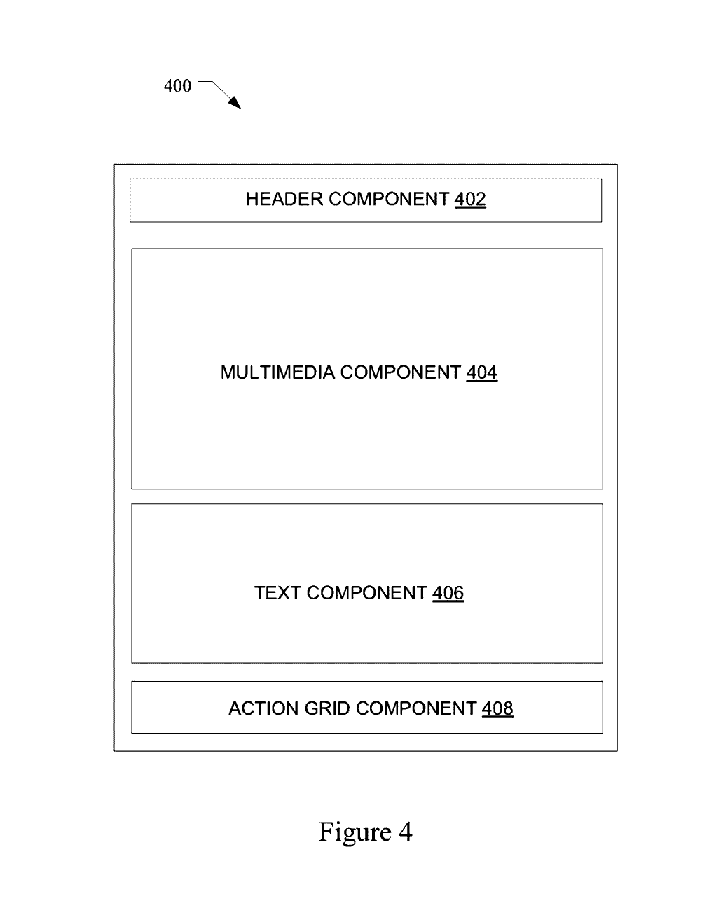

FIG. 4 illustrates an exemplary content card 400, in accordance with an embodiment. The impending description of the FIG. 4 has been presented in conjunction with the description of the FIGS. 1, 2, and 3. In an embodiment, the content card 400 may be of a defined format. In an example, the defined format of the content card 400 may be of manner so as to enhance the scalability of providing the content to the users. For instance, content from multiple sources may be presented in a standardized manner through the defined format. In an example, the content card 400 may comprise a header component 402, a multimedia component 404, a text component 406, and an action grid component 408. The header component 402, in an example, comprises a title of the content card 400. The multimedia component 404 comprises one or more of an image, a gif file, a music file, an audio file, a multimedia file, a FLASH file, and a video file associated with the content to which the content card corresponds. The text component 406 comprises text associated with the content. For instance, in a case where the content card corresponds to a news article, the text component 406 may include a summary of the article and a URL to the full text of the news article. In another instance, the text component 406 may comprise a full text of the content. In another instance, the text component 406 may comprise a description of the content presented in the multimedia component 404. Further, the action grid component 408 may include one or more action components for affecting user actions. Examples of the user actions include, but are not limited to like, dislike, share, follow, repost, and pin. In an embodiment, the system 102 (not shown in the figure) may be configured to disable certain action components for certain content cards. For instance, the system 102 may disable the like component for content cards comprising news content related to unfortunate events, such as, crime reports, natural disasters, and the like.

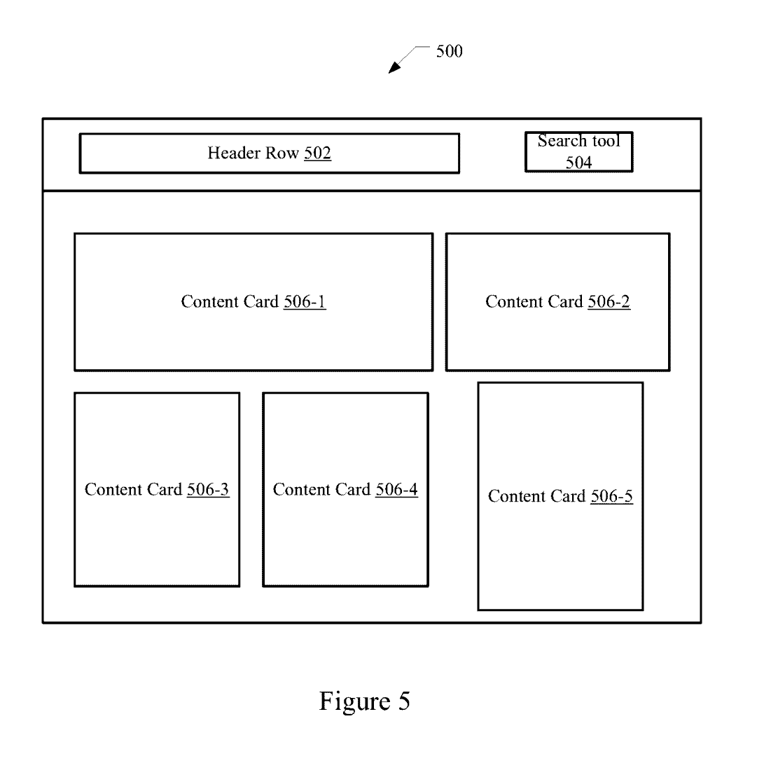

FIG. 5 illustrates an exemplary user interface 500, in accordance with an embodiment. As shown in the figure, the UI 500 comprises a header row 502, a search tool 504, and a plurality of content cards 506-1, 506-2, 506-3, 506-4, . . . , and 506-5. The header row 502, in an example, may be used to display information associated with an entity implementing the system 102. Examples of the entity may include, but are not limited to, an enterprise, a content provider, a third party content provider, and the like. The search 504 may be understood as a tool configured to search for content cards based on, for example, a user query received from the user. The content cards 500 comprise content relevant to the user.

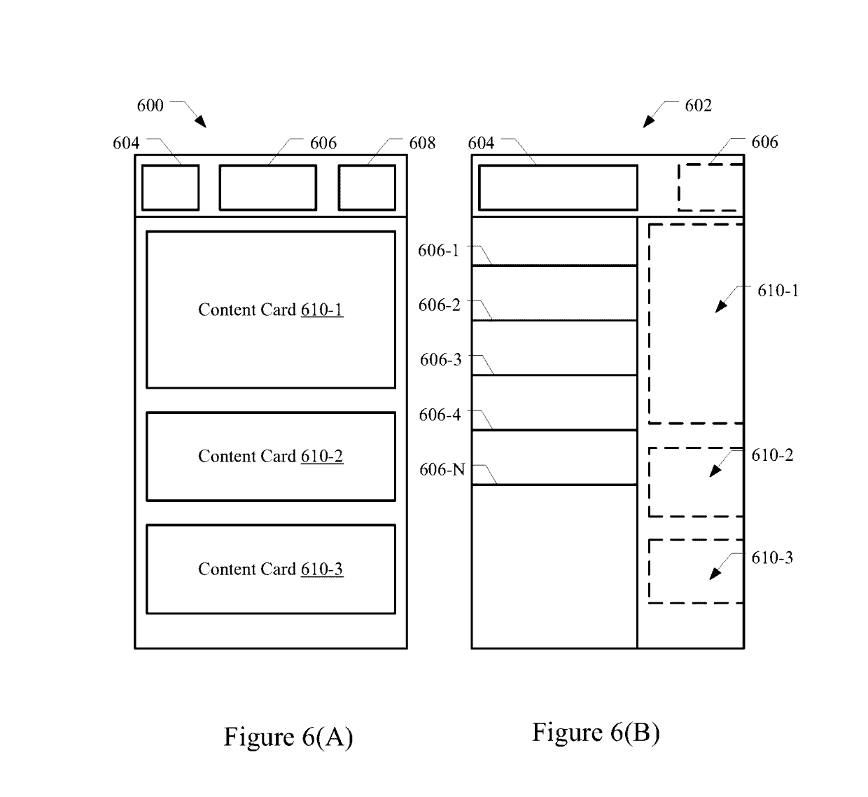

FIGS. 6(A) and 6(B) illustrate exemplary user interfaces 600 and 602, in accordance with an embodiment. The user interfaces 600 and 602 comprise a link component 604, a header row 606, a search tool 608, and a plurality of content cards 610. The link component 604 may be understood as a tool which when selected by the user provides access to a plurality of links 606. The links 606 may be understood as hyperlinks to one or more services provided by the entity. For instance, in a case where the entity deploying the system 102 is a shopping mall, the UI 600 and 602 may provide access to one or more services provided by the shopping mall. In an example implementation, upon clicking on the link component 604 displayed in the user interface 600 may present the user interface 602. Thus, access to a plurality of links 606-1, 606-2, 606-3, 606-4, . . . , and 606-5 is provided.

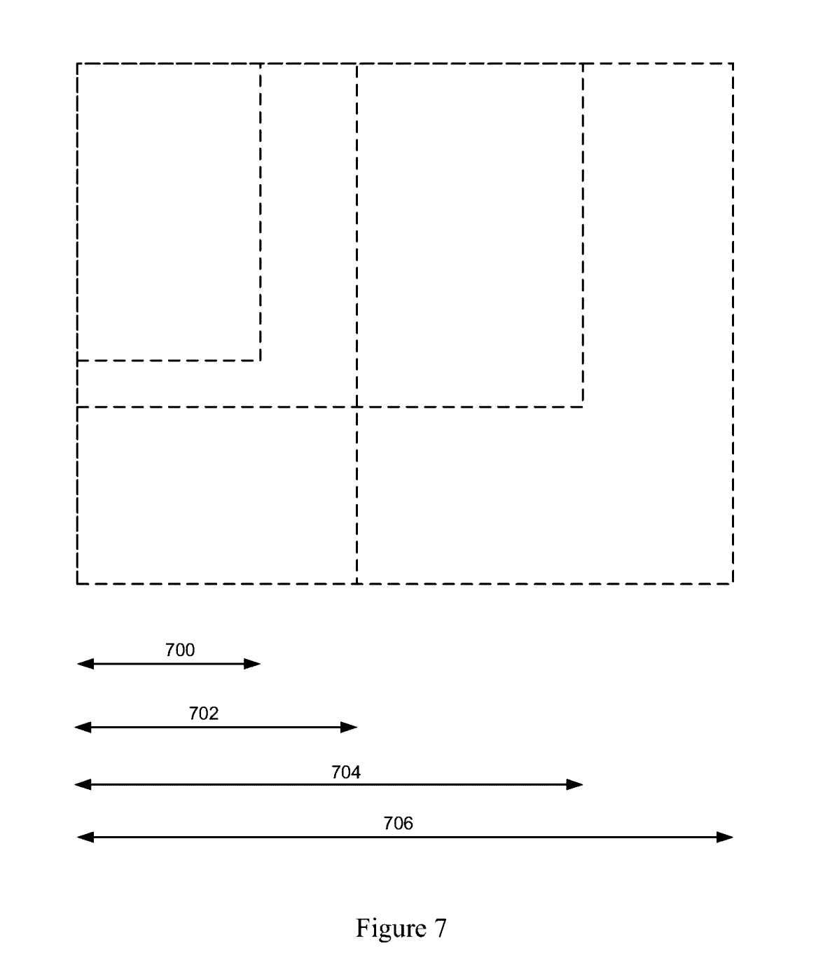

FIG. 7 illustrates user interface orientations, in accordance with an embodiment. As mentioned above, the users may user a variety of communication devices for accessing the content. For instance, one user may user a smartphone, while another user may user a tablet, and yet another may use a desktop. In an embodiment, the system 102 is configured to determine a type and an orientation of the communication device through which the user is viewing the content. Based on the type and orientation of the communication device, the system 102 may configure the UI of the communication device to display the content cards based on the type and orientation of the communication device. Exemplary UI orientations in which the content cards are shown herein.

As shown in the FIG. 7, a UI orientation 700 corresponds to a portrait orientation of a smart phone. Further, a UI orientation 702 corresponds to a portrait orientation of a tablet and a UI orientation 704 corresponds to a landscape orientation of a tablet. Further, as shown in the figure, a UI orientation 706 corresponds to an orientation of a desktop.

In an embodiment, in addition to the UI of the communication device, the system 102 may be configured to provide the content cards based on a platform, for instance, a browser, an application, an internal portal, and the like, through which the user is accessing the content.

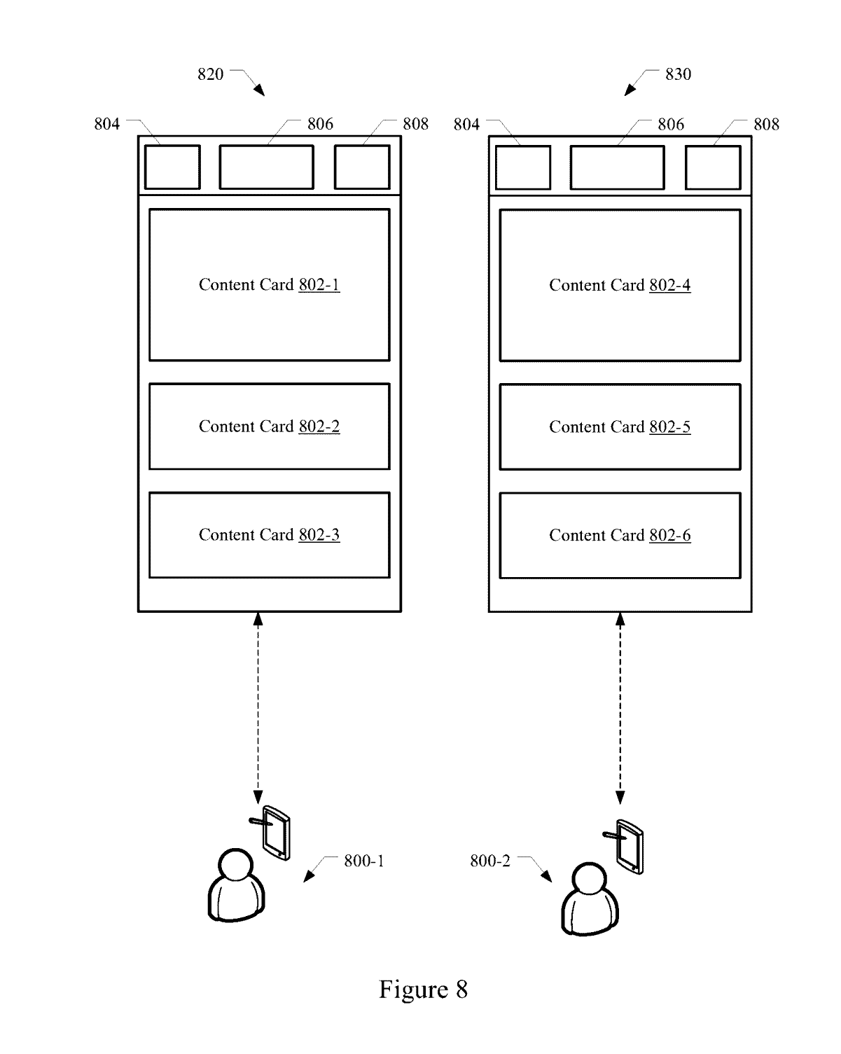

FIG. 8 illustrates example use case scenarios for recommending content to users, in accordance with an embodiment. As mentioned previously, the system 102 is configured to recommend different sets of content cards to different users. Consider an example case where the system 102 is implemented in an enterprise. In said example, different employees of the enterprise may be provided with different sets of content cards customized based on the employee trying to view the content cards. For instance, an employee 800-1 who may be a manager in the enterprise may be presented with content associated with team members of a team of the manager. Further, confidential content of the enterprise, for instance, accounts reports, may also be provided to the employee 800-1 through the content cards. As shown in the figure, the employee 800-1 may view the content cards through a user interface 820. The user interface 820 comprises a link component 804, a header row 806, a search tool 808, and content cards 802-1 to 802-3. On the other hand, an employee 800-2 who is new to the enterprise may be provided content cards comprising information about the enterprise, information about a department to which the employee 800-2 may belong, the enterprise's policy documents, information helpful to a new employee, etc. As shown in the figure, the employee 800-2 may view the content cards through a user interface 830. The user interface 830 comprises the link component 804, the header row 806, the search tool 808, and content cards 802-4 to 802-6. The employee 800-2 may not be provided with content cards comprising confidential information.

In another example use case, where the system 102 is implemented by a clothing shopping portal, the sets of content cards may be provided based on the users trying to access the portal. For instance, a user 800-1 who is of age 35 and is a working professional may be provided content cards related to formal clothing attire. While a user 800-2 who is of age 19 and is a college student may be provided content cards related to casual clothing attire.

The system, the method, and the computer program product of the present disclosure thus facilitates in providing personalized content to the users. As described above, content to a user is provided in the form of content cards displayed in a display order such that most relevant content cards are displayed first to the user. Thus, probability of a user to engage with the content increases. Further, as mentioned above, the display order of the content cards is determined based on a plurality of recommendation algorithms. The plurality of recommendation algorithms facilitate in personalizing the display order in a manner as described above. Further, aspects of the present disclosure may be implemented by content providers, such as, shopping portals, gaming websites, multimedia streaming websites, social networking platforms, individual brands and entities, and the like. The aspects described above facilitate operation growth as content providers, brands and entities can learn about users' interest and subsequently provide content relevant to the user. Further, enterprises can implement the aforementioned aspects for providing a common platform for employees for viewing enterprise data. Further, as mentioned above the system may be deployed using a cloud platform and, may render support for distributed computing technologies. Thus, scalability and speed of operation of the system is enhanced. Also, support for a plurality of communication devices and user interfaces is provided. Thus, the system as described herein is highly scalable.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system comprising:
a processing unit configured to,
generate a plurality of content cards based on user data associated with a user;
determine a display order for the plurality of content cards based on a plurality of recommendation algorithms; and
providing the plurality of content cards on a user interface of a user device of the user based on the display order.

2. The system as claimed in claim 1, wherein the processing unit is further configured to:
generate the user data associated with the user based on one or more data sources;
determine a plurality of user preferences based on the user data; and
fetch content from the one or more data sources based on the plurality of user preferences, wherein each of the plurality of content cards comprises at least a part of the content.

3. The system as claimed in claim 2, wherein the processing unit is further configured to:
monitor one or more user actions performed by the user in the user interface;
assign a weight to each of the one or more user actions;
update a plurality of user preferences defined in the user data based on the assigned weights to obtain updated user data; and
update the plurality of content cards based on the updated user data.

4. The system as claimed in claim 2, wherein, for each of the plurality of content cards, the processing unit is further configured to convert the part of the content to a defined format.

5. The system as claimed in claim 1, wherein the plurality of recommendation algorithms comprises at least one recommendation algorithm based on the user data and at least one recommendation algorithm based on the plurality of content cards.

6. The system as claimed in claim 1, wherein the processing unit is further configured to update a content card based on a user request.

7. The system as claimed in claim 1, wherein the processing unit is further configured to determine the display order based at least on a run sequence of the plurality of recommendation algorithms.

8. A method comprising:
generating a plurality of content cards based on user data associated with a user;
determine a display order for the plurality of content cards based on a plurality of recommendation algorithms; and
providing the plurality of content cards on a user interface of a user device of the user based on the display order.

9. The method as claimed in claim 8, wherein the method further comprises:
generating the user data associated with the user based on one or more data sources;
determining a plurality of user preferences based on the user data; and
fetching content from the one or more data sources based on the plurality of user preferences, wherein each of the plurality of content cards comprises at least a part of the content.

10. The method as claimed in claim 9, wherein the method further comprises:
monitoring one or more user actions performed by the user in the user interface;
assigning a weight to each of the one or more user actions;
updating a plurality of user preferences defined in the user data based on the assigned weights to obtain updated user data; and
updating the plurality of content cards based on the updated user data.

11. The method as claimed in claim 9, wherein, the method further comprises, for each of the plurality of content cards, converting the part of the content to a defined format.

12. The method as claimed in claim 8, wherein the plurality of recommendation algorithms comprises at least recommendation algorithm based on the user data and at least one recommendation algorithm based on the plurality of content cards.

13. The method as claimed in claim 8, wherein the method further comprises updating a content card based on a user request.

14. The method as claimed in claim 8, wherein the method further comprises determining the display order based at least on a run sequence of the plurality of recommendation algorithms.

15. A computer program product, comprising:
a non-transitory computer readable storage medium; and
a computer program code embedded in the non-transitory computer readable storage medium for causing a processing unit to:
generate a plurality of content cards based on user data associated with a user;
determine a display order for the plurality of content cards based on a plurality of recommendation algorithms; and
providing the plurality of content cards on a user interface of a user device of the user based on the display order.

16. The computer program product of claim 15, further comprising computer program code embedded in the non-transitory computer readable storage medium for causing the processing unit to:
generating the user data associated with the user based on one or more data sources;
determine a plurality of user preferences based on the user data; and
fetch content from the one or more data sources based on the plurality of user preferences, wherein each of the plurality of content cards comprises at least a part of the content.

17. The computer program product of claim 16, further comprising computer program code embedded in the non-transitory computer readable storage medium for causing the processing unit to:
monitor one or more user actions performed by the user in the user interface;
assign a weight to each of the one or more user actions;
update a plurality of user preferences defined in the user data based on the assigned weights to obtain updated user data; and
update the plurality of content cards based on the updated user data.

18. The computer program product of claim 16, further comprising computer program code embedded in the non-transitory computer readable storage medium for causing the processing unit to, convert corresponding content of each of the plurality of content cards to a defined format.

19. The computer program product of claim 15, wherein the plurality of recommendation algorithms comprises at least recommendation algorithm based on the user data and at least one recommendation algorithm based on the plurality of content cards.

20. The computer program product of claim 15, further comprising computer program code embedded in the non-transitory computer readable storage medium for causing the processing unit to, update a content card based on a user request.

21. The computer program product of claim 15, further comprising computer program code embedded in the non-transitory computer readable storage medium for causing the processing unit to, determine the display order based at least on a run sequence of the plurality of recommendation algorithms.
